(19) United States
(12) Patent Application Publication
(10) Pub. No.: US 2013/0088413 A1
(43) Pub. Date: Apr. 11, 2013

(54) Method to Autofocus on Near-Eye Display

(71) Applicants: Hayes Solos Raffle, Palo Alto, CA (US); Adrian Wong, Mountain View, CA (US); Xiaoyu Miao, Sunnyvale, CA (US)

(72) Inventors: Hayes Solos Raffle, Palo Alto, CA (US); Adrian Wong, Mountain View, CA (US); Xiaoyu Miao, Sunnyvale, CA (US)

(73) Assignee: Google Inc., Mountain View, CA (US)

(21) Appl. No.: 13/253,419

(22) Filed: Oct. 5, 2011

(51) Int. Cl. G09G 5/00; G02B 27/01

(52) U.S. Cl. 345/7; 359/630

(57) ABSTRACT

An optical system has an aperture through which virtual and real-world images are viewable along a viewing axis. The optical system may be incorporated into a head-mounted display (HMD). By modulating the length of the optical path along an optical axis within the optical system, the virtual image may appear to be at different distances away from the HMD wearer. The wearable computer of the HMD may be used to control the length of the optical path. The length of the optical path may be modulated using, for example, a piezoelectric actuator or stepper motor. By determining the distance to an object with respect to the HMD using a range-finder or autofocus camera, the virtual images may be controlled to appear at various distances and locations in relation to the target object and/or HMD wearer.

### BACKGROUND

Wearable systems can integrate various elements, such as miniaturized computers, input devices, sensors, detectors, image displays, wireless communication devices as well as image and audio processors, into a device that can be worn by a user. Such devices provide a mobile and lightweight solution to communicating, computing and interacting with one's environment. With the advance of technologies associated with wearable systems and miniaturized optical elements, it has become possible to consider wearable compact optical displays that augment the wearer's experience of the real world.

By placing an image display element close to the wearer's eye(s), an artificial image can be made to overlay the wearer's view of the real world. Such image display elements are incorporated into systems also referred to as “near-eye displays”, “head-mounted displays” (HMDs) or “heads-up displays” (HUDs). Depending upon the size of the display element and the distance to the wearer's eye, the artificial image may fill or nearly fill the wearer's field of view.

### SUMMARY

In a first aspect, an optical system is provided. The optical system includes a display panel, an image former, a viewing window, a proximal beam splitter, a distal beam splitter, and an optical path length modulator. The display panel is configured to generate a light pattern. The image former is configured to form a virtual image from the light pattern. The viewing window is configured to allow outside light into the optical system. The outside light and the virtual image are viewable through a proximal beam splitter along a viewing axis. The distal beam splitter is optically coupled to the display panel and the proximal beam splitter. The optical path length modulator is configured to adjust an optical path length between the display panel and the image former.

In a second aspect, a head-mounted display is provided. The head-mounted display includes a head-mounted support, at least one optical system, and a computer. The at least one optical system includes a display panel, an image former, a viewing window, a proximal beam splitter, a distal beam splitter, and an optical path length modulator. The display panel is configured to generate a light pattern. The image former is configured to form a virtual image from the light pattern. The viewing window is configured to allow outside light into the optical system. The outside light and the virtual image are viewable through the proximal beam splitter along a viewing axis. The distal beam splitter is optically connected to the display panel and the proximal beam splitter. The optical path length modulator is configured to adjust an optical path length between the display panel and the image former. The computer is configured to control the display panel and the optical path length modulator.

In a third aspect, a method is provided. The method includes determining a target object distance to a target object viewable in a field of view through an optical system. The optical system is configured to display virtual images that are formed by an image former from light patterns generated by a display panel. The method further includes selecting a virtual image and controlling the optical system to display the virtual image at an apparent distance corresponding to the target object distance.

In a fourth aspect, a non-transitory computer medium is provided that has stored instructions executable by a computing device to cause the computing device to perform certain functions. These functions include determining a target object distance to a target object viewable in a field of view through an optical system. The optical system is configured to display virtual images formed by an image former from light patterns generated by a display panel. The functions further include selecting a virtual image that relates to the target object and controlling the optical system to display the selected virtual image at an apparent distance related to the target object distance.

In a fifth aspect, a head-mounted display (HMD) is provided, including a head-mounted support and at least one optical system attached to the head-mounted support. The optical system includes a display panel configured to generate a light pattern, an image former configured to form a virtual image from the light pattern, a viewing window configured to allow light in from outside of the optical system, and a proximal beam splitter through which the outside light and the virtual image are viewable along a viewing axis. The optical system further includes a distal beam splitter optically coupled to the display panel and proximal beam splitter, and an optical path length modulator configured to adjust an optical path length between the display panel and the image former. The HMD further includes an autofocus camera configured to image the real-world environment to obtain an autofocus signal, and a computer that is configured to control the display panel and the optical path length modulator based on the autofocus signal.

In a sixth aspect, a method is provided. The method includes receiving an autofocus signal from an autofocus camera wherein the autofocus signal is related to a target object in an environment of an optical system, wherein the optical system is configured to display virtual images formed by an image former from light patterns generated by a display panel. The method further includes selecting a virtual image and controlling the optical system based on the autofocus signal so as to display the virtual image at an apparent distance related to the target object.

In a seventh aspect, a non-transitory computer medium is provided that has stored instructions executable by a computing device to cause the computing device to perform certain functions. These functions include receiving an autofocus signal from an autofocus camera wherein the autofocus signal is related to a target object in an environment of an optical system. The optical system is configured to display a virtual image formed by an image former from light patterns generated by a display panel. The functions further include controlling the optical system based on the autofocus signal so as to display the virtual image at an apparent distance related to the target object.

### BRIEF DESCRIPTION OF THE DRAWINGS

FIG. 1 is a functional block diagram of a wearable computing device that includes a head-mounted display (HMD), in accordance with an example embodiment.

FIG. 2 is a top view of an optical system, in accordance with an example embodiment.

FIG. 3 is a graph illustrating the change in virtual image apparent distance versus the change in optical path length, in accordance with an example embodiment.

FIG. 4A is a front view of a head-mounted display, in accordance with an example embodiment.

FIG. 4B is a top view of the head-mounted display of FIG. 3A, in accordance with an example embodiment.

FIG. 4C is a side view of the head-mounted display of FIG. 3A and FIG. 3B, in accordance with an example embodiment.

FIG. 5A shows a real-world view through a head-mounted display, in accordance with an example embodiment.

FIG. 5B shows a close virtual image overlaying a real-world view through a head-mounted display, in accordance with an example embodiment.

FIG. 5C shows a distant virtual image overlaying a real-world view through a head-mounted display, in accordance with an example embodiment.

FIG. 6 is a flowchart illustrating a method, in accordance with an example embodiment.

FIG. 7 is a flowchart illustrating a method, in accordance with an example embodiment.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description and figures are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

1. Overview

A head-mounted display (HMD) may enable its wearer to observe the wearer's real-world surroundings and also view a displayed image, such as a computer-generated image. In some cases, the displayed image may overlay a portion of the wearer's field of view of the real world. Thus, while the wearer of the HMD is going about his or her daily activities, such as walking, driving, exercising, etc., the wearer may be able to see a displayed image generated by the HMD at the same time that the wearer is looking out at his or her real-world surroundings.

The displayed image might include, for example, graphics, text, and/or video. The content of the displayed image could relate to any number of contexts, including but not limited to the wearer's current environment, an activity in which the wearer is currently engaged, the biometric status of the wearer, and any audio, video, or textual communications that have been directed to the wearer. The images displayed by the HMD may also be part of an interactive user interface. For example, the HMD could be part of a wearable computing device. Thus, the images displayed by the HMD could include menus, selection boxes, navigation icons, or other user interface features that enable the wearer to invoke functions of the wearable computing device or otherwise interact with the wearable computing device.

The images displayed by the HMD could appear anywhere in the wearer's field of view. For example, the displayed image might occur at or near the center of the wearer's field of view, or the displayed image might be confined to the top, bottom, or a corner of the wearer's field of view. Alternatively, the displayed image might be at the periphery of or entirely outside of the wearer's normal field of view. For example, the displayed image might be positioned such that it is not visible when the wearer looks straight ahead but is visible when the wearer looks in a specific direction, such as up, down, or to one side. In addition, the displayed image might overlay only a small portion of the wearer's field of view, or the displayed image might fill most or all of the wearer's field of view. The displayed image could be displayed continuously or only at certain times (e.g., only when the wearer is engaged in certain activities).

The HMD may utilize an optical system to present virtual images overlaid upon a real-world view to a wearer. To display a virtual image to the wearer, the optical system may include a light source, such as a light-emitting diode (LED), that is configured to illuminate a display panel, such as a liquid crystal-on-silicon (LCOS) display. The display panel generates light patterns by spatially modulating the light from the light source, and an image former forms a virtual image from the light pattern. The length of the optical path between the display panel and the image former determines the apparent distance at which the virtual image appears to the wearer. The length of the optical path can be adjusted by, for example, adjusting a gap dimension, d, where d is some distance within the optical path. In one example, by adjusting the gap dimension over a range of 2 millimeters, the apparent distance of the image might be adjustable between about 0.5 to 4 meters. The gap dimension, d, could be adjusted by using, for example, a piezoelectric motor, a voice coil motor, or a MEMS actuator.

The apparent distance of the image could be adjusted manually by the user. Alternatively, the apparent distance and scale of the virtual image could be adjusted automatically based upon what the user is looking at. For example, if the user is looking at a particular object (which may be considered a ‘target object’) in the real world, the apparent distance of the virtual image may be adjusted so that it corresponds to the location of the target object. If the virtual image is superimposed or displayed next to a particular target object, the image could be made a larger (or smaller) as the distance between the user and the target object becomes smaller (or larger). Thus, the apparent distance and apparent size of the virtual image could both be adjusted based upon the target object distance.

In addition to adjusting the apparent distance and scale of the virtual image, the location of the virtual image within the wearer's field of view could be adjusted. This may be accomplished by using one or more actuators that move part of the optical system up, down, left, or right. This may allow the user to control where a generated image appears. For example, if the user is looking at a target object near the middle of the wearer's field of view, the user may move a generated virtual image to the top or bottom of the wearer's field of view so the virtual image does not occlude the target object.

The brightness and contrast of the generated display may also be adjusted, for example, by adjusting the brightness and contrast of the LED and display panel. The brightness of the generated display could be adjusted automatically based upon, among other factors, the ambient light level at the user's location. The ambient light level could be determined by a light sensor or by a camera mounted near the wearable computer.

Certain illustrative examples of adjusting aspects of a virtual image displayed by an optical system are described below. It is to be understood, however, that other embodiments are possible and are implicitly considered within the context of the following example embodiments.

2. Example Optical System and Head-Mounted Display with Optical Path Length Modulator for Virtual Image Adjustment

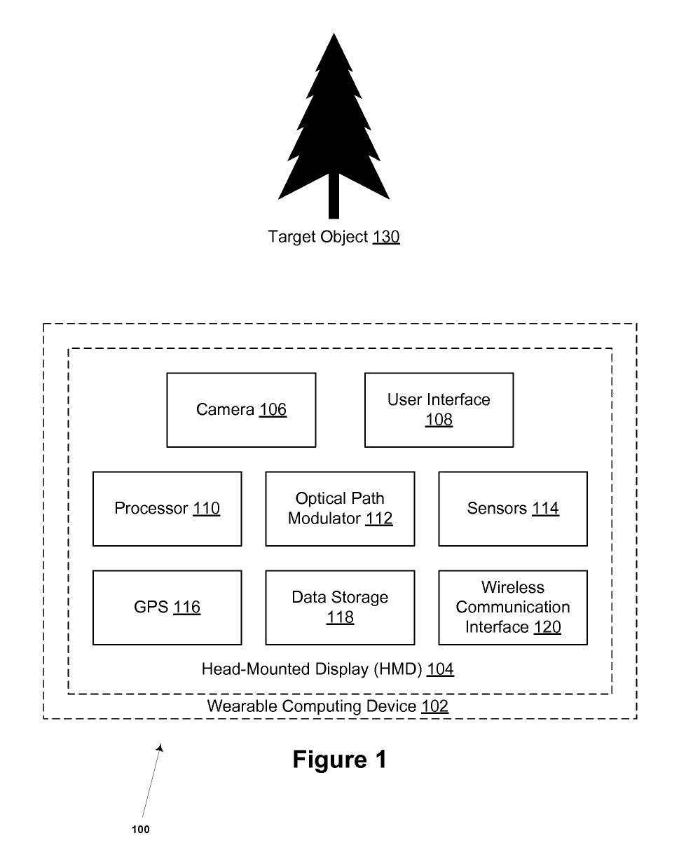

FIG. 1 is a functional block diagram 100 of a wearable computing device 102 that includes a head-mounted display (HMD) 104. In an example embodiment, HMD 104 includes a see-through display. Thus, the wearer of wearable computing device 102 may be able to look through HMD 104 and observe a portion of the real-world environment of the wearable computing device 102, i.e., in a particular field of view provided by HMD 104. In addition, HMD 104 is operable to display images that are superimposed on the field of view, for example, to provide an “augmented reality” experience. Some of the images displayed by HMD 104 may be superimposed over particular objects in the field of view, such as target object 130. However, HMD 104 may also display images that appear to hover within the field of view instead of being associated with particular objects in the field of view.

The HMD 104 may further include several components such as a camera 106, a user interface 108, a processor 110, an optical path length modulator 112, sensors 114, a global positioning system (GPS) 116, data storage 118 and a wireless communication interface 120. These components may further work in an interconnected fashion. For instance, in an example embodiment, GPS 116 and sensors 114 may detect that target object 130 is near the HMD 104. The camera 106 may then produce an image of target object 130 and send the image to the processor 110 for image recognition. The data storage 118 may be used by the processor 110 to look up information regarding the imaged target object 130. The processor 110 may further control the optical path modulator 112 to adjust the apparent distance of a displayed virtual image, which may be a component of the user interface 108. The individual components of the example embodiment will be described in more detail below.

HMD 104 could be configured as, for example, eyeglasses, goggles, a helmet, a hat, a visor, a headband, or in some other form that can be supported on or from the wearer's head. Further, HMD 104 may be configured to display images to both of the wearer's eyes, for example, using two see-through displays. Alternatively, HMD 104 may include only a single see-through display and may display images to only one of the wearer's eyes, either the left eye or the right eye. The HMD 104 may also represent an opaque display configured to display images to one or both of the wearer's eyes without a view of the real-world environment. Further, the HMD 104 could provide an opaque display for one eye of the wearer as well as provide a view of the real-world environment for the other eye of the wearer.

The function of wearable computing device 102 may be controlled by a processor 110 that executes instructions stored in a non-transitory computer readable medium, such as data storage 118. Thus, processor 110 in combination with instructions stored in data storage 118 may function as a controller of wearable computing device 102. As such, processor 110 may control HMD 104 in order to control what images are displayed by HMD 104. Processor 110 may also control wireless communication interface 120.

In addition to instructions that may be executed by processor 110, data storage 118 may store data that may facilitate interactions with various features within an environment, such as target object 130. For example, data storage 118 may function as a database of information related to target objects. Such information may be used by wearable computing device 102 to identify target objects that are detected within the environment of wearable computing device 102 and to define what images are to be displayed by HMD 104 when target objects are identified.

Wearable computing device 102 may also include a camera 106 that is configured to capture images of the environment of wearable computing device 102 from a particular point-of-view. The images could be either video images or still images. The point-of-view of camera 106 may correspond to the direction where HMD 104 is facing. Thus, the point-of-view of camera 106 may substantially correspond to the field of view that HMD 104 provides to the wearer, such that the point-of-view images obtained by camera 106 may be used to determine what is visible to the wearer through HMD 104. Camera 106 may be mounted on the head-mounted display or could be directly incorporated into the optical system that provides virtual images to the wearer of HMD 104. The point-of-view images may be used to detect and identify target objects that are within the environment of wearable computing device 102. The image analysis could be performed by processor 110.

In addition to image analysis of point-of-view images obtained by camera 106, target object 130 may be detected and identified in other ways. In this regard, wearable computing device 102 may include one or more sensors 114 for detecting when a target object is within its environment. For example, sensors 114 may include a radio frequency identification (RFID) reader that can detect an RFID tag on a target object. Alternatively or additionally, sensors 114 may include a scanner that can scan a visual code, such as bar code or QR code, on the target object. Further, sensors 114 may be configured to detect a particular beacon signal transmitted by a target object. The beacon signal could be, for example, a radio frequency signal or an ultrasonic signal.

A target object 130 could also be determined to be within the environment of wearable computing device 102 based on the location of wearable computing device 102. For example, wearable computing device 102 may include a Global Positioning System (GPS) receiver 116 that is able to determine the location of wearable computing device 102. Wearable computing device 102 may then compare its location to the known locations of target objects (e.g., locations stored in data storage 118) to determine when a particular target object is in the vicinity. Alternatively, wearable computing device 102 may communicate its location to a server network via wireless communication interface 120, and the server network may respond with information relating to any target objects that are nearby.

Wearable computing device 102 may also include a user interface 108 for receiving input from the wearer. User interface 108 could include, for example, a touchpad, a keypad, buttons, a microphone, and/or other input devices. Processor 110 may control the functioning of wearable computing device 102 based on input received through user interface 108. For example, processor 110 may use the input to control how HMD 104 displays images or what images HMD 104 displays.

In one example, the wearable computing device 102 may include a wireless communication interface 120 for wirelessly communicating with the target object 130 or with the internet. Wireless communication interface 120 could use any form of wireless communication that can support bi-directional data exchange over a packet network (such as the internet). For example, wireless communication interface 120 could use 3G cellular communication, such as CDMA, EVDO, GSM/GPRS, or 4G cellular communication, such as WiMAX or LTE. Alternatively, wireless communication interface 120 could communicate indirectly with the target object 130 via a wireless local area network (WLAN), for example, using WiFi. Alternatively, wireless communication interface 120 could communicate directly with target object 130 using an infrared link, Bluetooth, or ZigBee. The wireless communications could be uni-directional, for example, with wearable computing device 102 transmitting one or more control instructions for the target object 130, or the target object 130 transmitting a beacon signal to broadcast its location and/or hardware configuration. Alternatively, the wireless communications could be bi-directional, so that target object 130 may communicate status information in addition to receiving control instructions.

The target object 130 may represent any object or group of objects observable through HMD 104. For example, the target object 130 may represent environmental features such as trees and bodies of water, landmarks such as buildings and streets, or electrical or mechanical devices such as home or office appliances. The target object 130 may additionally represent a dynamically changing feature or set of features with which the wearer of the HMD 104 is currently interacting. Finally, the target object 130 may be alternatively understood as a feature that is the target of a search. For instance, the HMD may emit a beacon to initiate communication or interaction with the target object 130 before it is nearby or perform an image-recognition search within a field-of-view with camera 106 in an effort to find the target object 130. Other functional examples involving the target object 130 are also possible.

Although FIG. 1 shows various components of HMD 104, i.e., wireless communication interface 120, processor 110, data storage 118, camera 106, sensors 114, GPS 116, and user interface 108, as being integrated into HMD 104, one or more of these components could be mounted or associated separately from HMD 104. For example, camera 106 could be mounted on the user separate from HMD 104. Thus, wearable computing device 102 could be provided in the form of separate devices that can be worn on or carried by the wearer. The separate devices that make up wearable computing device 102 could be communicatively coupled together in either a wired or wireless fashion.

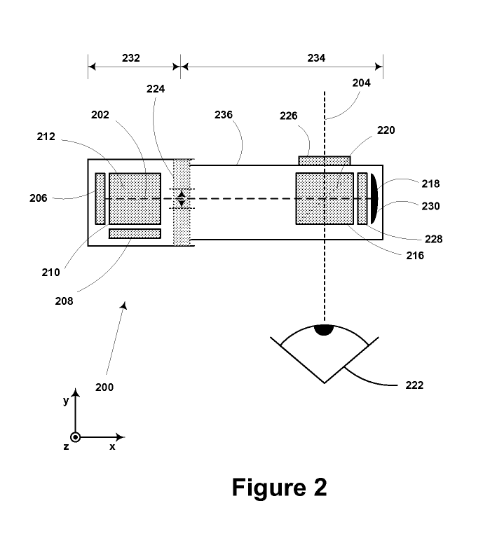

FIG. 2 illustrates a top view of an optical system 200 with an optical path 202 that generally is parallel to the x-axis. Optical system 200 allows adjustment of a virtual image superimposed upon a real-world scene viewable along a viewing axis 204. For clarity, a distal portion 232 and a proximal portion 234 represent optically-coupled portions of the optical system 200 that may or may not be physically separated. An example embodiment includes a display panel 206 that may be illuminated by a light source 208. Light emitted from a light source 208 is incident upon a distal beam splitter cube 210. The light source 208 may include one or more light-emitting diodes (LEDs) and/or laser diodes. The light source 208 may further include a linear polarizer that acts to pass one particular polarization to the rest of the optical system. In an example embodiment, the distal beam splitter cube 210 is a polarizing beam splitter cube that reflects light or passes light depending upon the polarization of light incident upon the beam splitter coating at interface 212. To illustrate, s-polarized light from the light source 208 may be preferentially reflected by a distal beam-splitting coating at interface 212 towards the display panel 206. The display panel 206 in the example embodiment is a liquid crystal-on-silicon (LCOS) display. In an alternate embodiment in which the beam splitter coating at interface 212 is not a polarization beam splitter, the display could be a digital light projector (DLP) micro-mirror display, or other type of reflective display panel. In either embodiment, the display panel 206 acts to spatially-modulate the incident light to generate a light pattern at an object plane in the display. Alternatively, the display panel 206 may be an emissive-type display such as an organic light-emitting diode (OLED) display, and in such a case, the beam splitter cube 210 is not needed.

In the example in which display panel 206 is a LCOS display panel, the display panel 206 generates a light pattern with a polarization perpendicular to the polarization of light initially incident upon the panel. In this example embodiment, the display panel 206 converts incident s-polarized light into a light pattern with p-polarization. The reflected light from the display panel 206, which carries the generated light pattern, is directed towards the distal beam splitter cube 210. The p-polarized light pattern passes through distal beam splitter cube 210 and is directed along optical axis 202 towards the proximal region of the optical system 200 in which it passes through optical path length modulator 224 and a light pipe 236. In an example embodiment, the proximal beam splitter cube 216 is also a polarizing beam splitter. The light pattern is at least partially transmitted through the proximal beam splitter cube 216 to the image former 218. In an example embodiment, image former 218 includes a concave mirror 230 and a proximal quarter-wave plate 228. The light pattern passes through the proximal quarter-wave plate 228 and is reflected by the concave mirror 230.

The reflected light pattern passes back through proximal quarter-wave plate 228. Through the interactions with the proximal quarter-wave plate 228 and the concave mirror 230, the light patterns are converted to the s-polarization and are formed into a viewable virtual image at a distance along axis 204. The light rays carrying this viewable image are incident upon the proximal beam splitter cube 216 and the rays are reflected from proximal beam splitting interface 220 towards a viewer 222 along a viewing axis 204, thus forming the viewable virtual image at a distance along axis 204. A real-world scene is viewable through a viewing window 226. The viewing window 226 may include a linear polarizer in order to reduce stray light within the optical system. Light from the viewing window 226 is at least partially transmitted through the proximal beam splitter cube 216. Thus, both a virtual image and a real-world image are viewable to a viewer 222 through the proximal beam splitter cube 216. Although the aforementioned beam splitter coatings at interfaces 212 and 220 are positioned within beam splitter cubes 210 and 216, the coatings may also be formed on a thin, free-standing glass sheet, or may comprise wire grid polarizers, or other means to split the light beams known in the art, or may be formed within structures that are not cubes.

An optical path length modulator 224 may adjust the length of optical path 202 by mechanically changing the distance between the display panel 206 and the image former 218. The optical path length modulator 224 may include, for example, a piezoelectric actuator or a stepper motor actuator. The optical path length modulator 224 could also be a shape memory alloy or electrical-thermal polymer actuator, as well as other means for micromechanical modulation known in the art. By changing the length of optical path 202, the virtual image may appear to the viewer 222 at a different apparent distance along path 204. In some cases, the optical path length modulator 224 may also be able to adjust the position of the distal portion of the optical system with respect to the proximal portion in order to move the location of the apparent virtual image around the wearer's field of view.

Although FIG. 2 depicts the distal portion 232 of the optical system housing as partially encasing the proximal portion 234 of the optical system housing, it is understood that other embodiments are possible to physically realize the optical system 200. Furthermore, in an example embodiment, the optical system 200 is configured such that the distal portion 232 of the optical system 200 is on the left with respect to the proximal portion 234. It is to be also understood that many configurations of the optical system 200 are possible, including the distal portion 232 being configured to be to the right, below and above with respect to the proximal portion 234.

The optical path 202 may include a single material or a plurality of materials, including glass, air, plastic, and polymer, among other possibilities. The optical path modulator 224 may adjust the distance of an air gap between two glass waveguides, in an example embodiment. The optical path modulator 224 may further comprise a material that can modulate the effective length of the optical path by, for instance, changing the material's refractive index.

In an example embodiment, the optical path modulator 224 may include an electrooptic material, such as lead zirconium titanate (PZT) that modulates its refractive index with respect to an applied voltage within the material. In such an example embodiment, light traveling within the electrooptic material may experience a modulated effective optical path length. Thus, the length of optical path 202 may be modulated in a physical length and/or in an effective optical path length.

The optical path length could be further modulated by changing the properties of image former 218. For instance, by changing the radius of curvature of the concave mirror 230, the focal length of the concave mirror may be adjusted. A deformable reflective material or a plurality of adjustable plane mirrors could be used for the concave mirror 230. Thus, changing the focal length of the image former 218 could be used to adjust the apparent depth of displayed virtual images. Other methods known in the art to modulate the optical path length or an effective optical path length are possible.

Further, the actual location of the optical path length modulator 224 may vary. In an example embodiment, the optical path length modulator 224 includes the modulation of an air gap distance that may occur between two glass waveguides near the light pipe 236. However, it is understood that the location of the optical path length modulator 224 may be located elsewhere in optical system 200. For instance, due to ergonomic and other practical considerations, it may be more desirable to modulate the physical length of the optical path 202 using an optical path length modulator 224 at or near the display panel 206 or at or near image former 218.

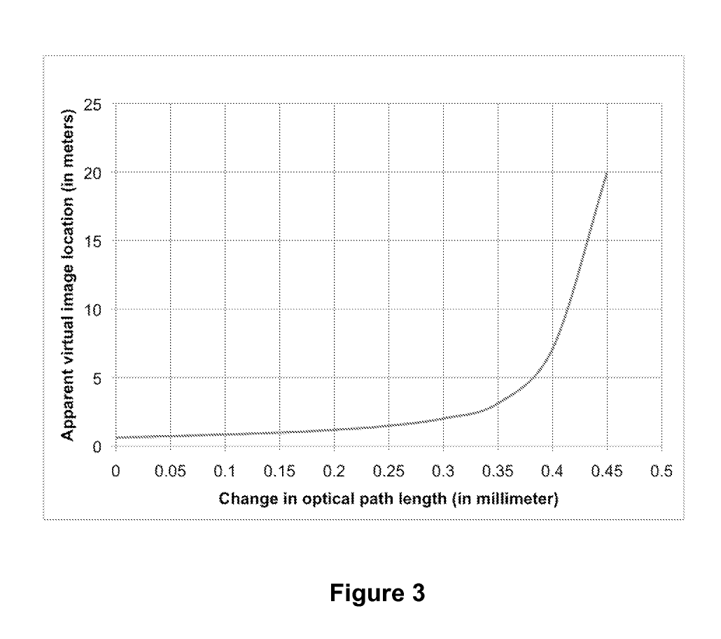

FIG. 3 is a graph illustrating the change in virtual image apparent distance versus change in the length of an optical path for an example embodiment that includes a concave mirror with a 90 mm radius of curvature and an 18 mm length of light pipe. As an air gap between two portions of the light pipe is increased from zero to 0.45 millimeters, the apparent virtual image location, which is the distance at which the virtual image appears to the viewer 222, may shift from approximately 0.6 to 20 meters. In practice, an operational range of 0.5 mm may be utilized to adjust the apparent distance of the virtual image from 0.5 meters all the way to approximately infinity. FIG. 3 demonstrates that relatively small changes in the length of optical path 202 in optical system 200 may substantially change the virtual image depth and location as seen by the viewer 222. It may desirable to implement this capability with a wearable system in order to present the wearer with virtual images that exhibit varying apparent depths and/or locations. Further, this change of length of the optical path could be controlled by a computer associated with a head-mounted display (HMD), for instance, to perform dynamic, automatic virtual image depth and location adjustments based upon the distance to a target object near the HMD.

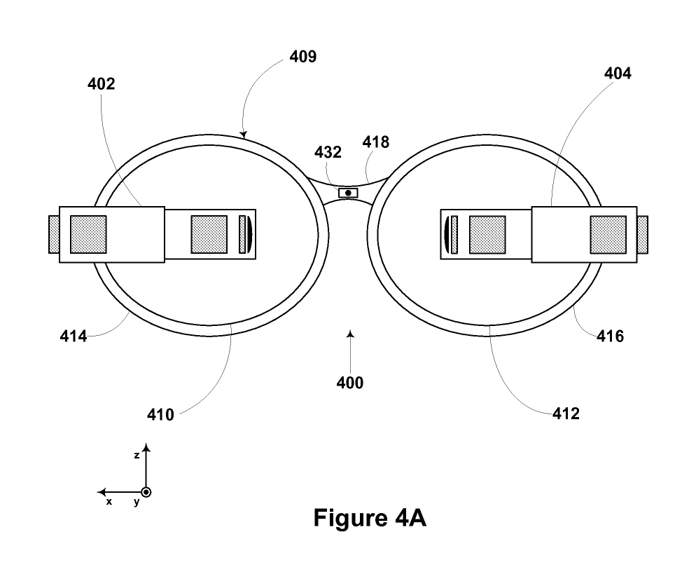

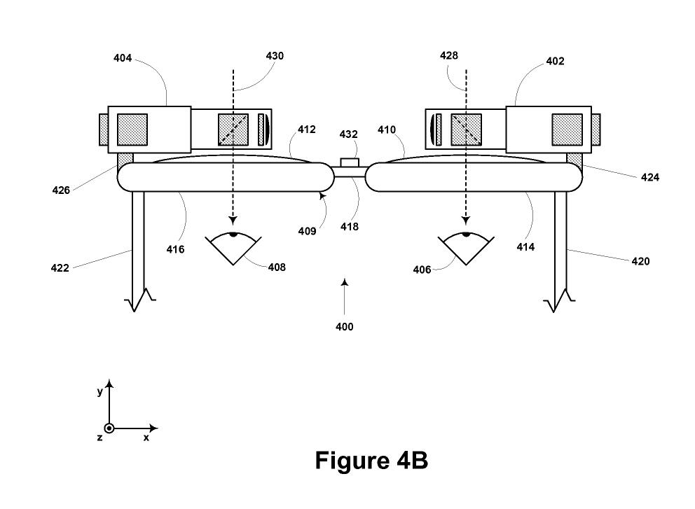

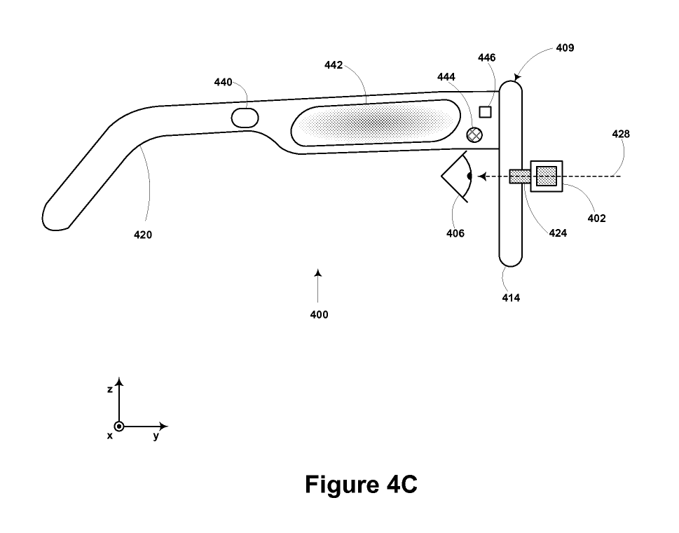

FIG. 4A presents a front view of a HMD 400 in an example embodiment that includes a head-mounted support 409. FIGS. 4B and 4C present the top and side views, respectively, of the HMD in FIG. 4A. Although an example embodiment is provided in an eyeglasses frame format, it will be understood that wearable systems and HMDs may take other forms, such as hats, goggles, masks, headbands and helmets. The head-mounted support 409 includes lens frames 412 and 414, a center frame support 418, lens elements 410 and 412, and extending side-arms 420 and 422. The center frame support 418 and side-arms 420 and 422 are configured to secure the head-mounted support 409 to the wearer's head via the wearer's nose and ears, respectively. Each of the frame elements 412, 414, and 418 and the extending side-arms 420 and 422 may be formed of a solid structure of plastic or metal, or may be formed of a hollow structure of similar material so as to allow wiring and component interconnects to be internally routed through the head-mounted support 409. Alternatively or additionally, head-mounted support 409 may support external wiring. Lens elements 410 and 412 are at least partially transparent so as to allow the wearer to look through them. In particular, the wearer's left eye 408 may look through left lens 412 and the wearer's right eye 406 may look through right lens 410.

Optical systems 402 and 404, which may be configured as shown in FIG. 2, may be positioned in front of lenses 410 and 412, respectively, as shown in FIGS. 4A, 4B, and 4C. Although this example includes an optical system for each of the wearer's eyes, it is to be understood, that a HMD might include an optical system for only one of the wearer's eyes (either left eye 408 or right eye 406). As described in another embodiment, the HMD wearer may simultaneously observe from optical systems 402 and 404 a real-world image with an overlaid virtual image. The HMD may include various elements such as a HMD computer 440, a touchpad 442, a microphone 444, a button 446 and a camera 432. The computer 440 may use data from, among other sources, various sensors and cameras to determine the virtual image that should be displayed to the user. Those skilled in the art would understand that other user input devices, user output devices, wireless communication hardware, sensors, and cameras may be reasonably included in such a wearable computing system.

The camera 432 may be part of the HMD 400, for example, located in the center frame support 418 of the head-mounted support 409 as shown in FIGS. 4A and 4B. Alternatively, the camera 432 may be located elsewhere on the head-mounted support 409, located separately from HMD 400, or be integrated into optical system 402 and/or optical system 404. The camera 432 may image a field of view similar to what the viewer's eyes 406 and 408 may see. Furthermore, the camera 432 allows the HMD computer 440 associated with the wearable system to interpret objects within the field of view, which may be important when displaying context-sensitive virtual images. For instance, if the camera 432 and associated HMD computer 440 detect a target object, the system could alert the user by displaying an overlaid artificial image designed to draw the user's attention to the target object. These images could move depending upon the user's field of view or target object movement, i.e. user head or target object movements will result in the artificial images moving around the viewable area to track the relative motion. Also, the system could display instructions, location cues and other visual cues to enhance interaction with the target object.

The camera 432 could be an autofocus camera that provides an autofocus signal. HMD computer 440 may adjust the length of optical path 202 in optical system 200 based on the autofocus signal in order to present virtual images that correspond to the environment.

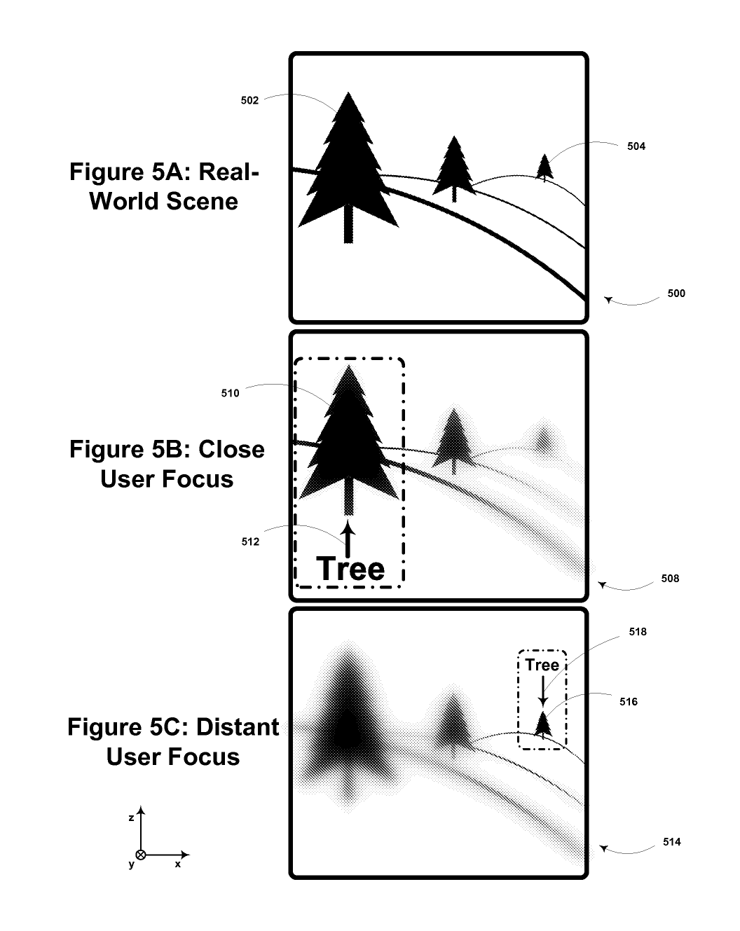

For instance, as illustrated in FIGS. 5A, 5B, and 5C, the computer 440 and optical system 200 may present virtual images at various apparent depths and scales. FIG. 5A provides a drawing of a real-world scene 500 with trees situated on hilltops at three different distances as may be viewable through an optical system 200. Close object 502 and distant object 504 are depicted as both in focus in this image. In practice, however, the wearer of an HMD may focus his or her eyes upon target objects at different distances, which may cause other objects viewable in a display device to be out of focus. FIG. 5B and FIG. 5C depict the same scene in which a wearer may focus specifically on a close target object or a distant target object, respectively. In a close focus situation 508, a close object 510 may be in focus as viewed by the wearer of an HMD. The HMD may utilize the camera 432 to image the scene and determine a target object distance to the close object 510 using a range-finder, such as a laser rangefinder, ultrasonic rangefinder or infrared rangefinder. Other means known in the art for range-finding are possible, such as LIDAR, RADAR, microwave range-finding, etc.

Additionally, the HMD may present a close virtual image 512 to the user, which may include, in an example embodiment, text, an arrow and a dashed border. The HMD computer 440 may act to adjust the length of optical path 202 such that the close virtual image 512 is provided at an apparent distance similar to that of the close object 510. In a distant focus situation 514, a distant object 516 may be in focus as viewed by the wearer of an HMD. The HMD may utilize the camera 432 to image the scene and determine the target object distance to the distant object 516. The HMD computer 440 may further act to adjust the length of optical path 202 such that the distant virtual image 518 is provided at an apparent distance similar to that of the distant object 516.

The HMD computer 440 may independently determine the target object, for instance by obtaining an image from the camera 432 and using image recognition to determine a target object of interest. The image recognition algorithm may, for instance, compare the image from the camera 432 to a collection of images of target objects of interest. Additionally, the wearer of the HMD may determine the target object or area within the wearer's field of view. For instance, an example embodiment may utilize a wearer action in order to ascertain the target object or location. In the example embodiment, the wearer may use the touchpad 442 or button 446 to input the desired location. In another example embodiment, the wearer may perform a gesture recognizable by the camera 432 and HMD computer 440. For instance, the wearer may make a gesture by pointing at a target object with his/her hand and arm.

The user inputs and gestures may be recognized by the HMD as a control instruction and the HMD may act to adjust the focus and/or depth-of-field with respect to the determined target object. Further, the HMD may include an eye-tracking camera that may track the position of the wearer's pupil in order to determine the wearer's direction of gaze. By determining the wearer's direction of gaze, the HMD computer 440 and camera 432 may adjust the length of optical path 202 in optical system 200 based on the wearer's direction of gaze.

The HMD computer 440 may control the optical system 200 to adjust other aspects of the virtual image. For instance, the optical system 200 may provide a close virtual image 512 that appears larger than a distant virtual image 518 by scaling the size of text and other graphical elements depending upon, for instance, the target object distance. The computer 440 may further control the optical system 200 to adjust the focal length of the image former. For instance, an example embodiment may include a liquid crystal autofocus element that may adjust the focus position of the image former to suit wearer preferences and individual physical characteristics. The HMD computer 440 may also control the optical system 200 to adjust the image display location of the virtual image as well as the virtual image brightness and contrast.

In a ‘binocular’ example embodiment as shown in FIG. 4A, where there may be virtual images presented to both eyes, the HMD computer 440 may control respective optical path length modulators in display devices 406 and 408 to adjust the respective virtual images with respect to one another and the target object. This may be useful to the wearer, for instance to circumvent slight misalignment between the display devices 406 and 408 and the wearer's eyes so that the left and right virtual images lie in a common plane. Additionally, this device may provide a different virtual image to each eye of the wearer (such as in a stereoscopic image), or provide an overlaid instance of a single virtual image in both eyes.

3. Example Method in an Optical System of Adjusting Virtual Image Apparent Distance with Respect to a Determined Target Object Distance

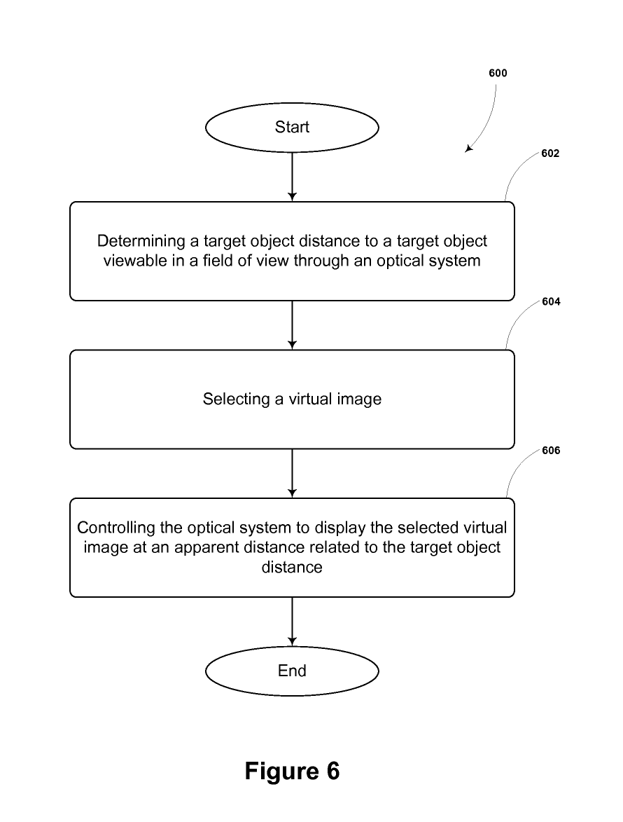

A method 600 is provided for an optical system to adjust a virtual image apparent distance in relation to a determined target object distance. FIG. 6 is a functional block diagram that illustrates an example set of steps, however, it is understood that the steps may appear in a different order and steps may be added or subtracted. In the method, a target object distance corresponding to an observable target object in a field of view may be first determined (method element 602). In an example embodiment previously described, this distance determination may be conducted using a range-finding apparatus such as a laser rangefinder. A virtual image may be selected that relates to the target object (method element 604). As in an example embodiment previously described, the selected virtual image may comprise text, graphics, or other visible elements. The selected virtual image may be scaled, moved, or otherwise adjusted depending upon the target object position, ambient conditions, and other factors. In an example embodiment, an optical system may display the selected virtual image with an apparent distance corresponding to the target object distance (method element 606). As in the close and distant focus situations in FIGS. 5B and 5C, respectively, text, an arrow, and a graphical highlight may be presented to a wearer, scaled appropriately for the target object distance. This method may be implemented in a dynamic fashion such that the selected virtual image is updated continuously to match changing viewing angle, user motion, and target object motion, among other situations.

The selected virtual image apparent distance need not correspond identically with a target object distance. In fact, the selected virtual image apparent distance may be intentionally offset to present various data to an HMD user. For instance, it may be important to display an apparent three-dimensional virtual image, which could be provided by dynamically displaying virtual images at different apparent distances with respect to a real-world target object and/or the HMD user.

4. Example Method Using an Autofocus Mechanism to Adjust Virtual Image Apparent Distance with Respect to a Determined Target Object Distance

Optical system 200 illustrates an example embodiment in which a length of an optical path 202 is modulated by an optical path length modulator 224, and wherein the optical path length modulator 224 is located between the distal beam splitter 210 and proximal beam splitter 216. As described previously, the placement of the optical path length modulator 224 may vary. Additionally, an autofocus mechanism could be used to produce an autofocus signal used to control the optical path length modulator 224 to adjust the apparent distance of the virtual image. For example, the focal length of the display optics may be based on the autofocus signal produced from the autofocus mechanism.

In an example embodiment wherein the autofocus mechanism may be used as a control device, a camera autofocus mechanism and related components could be mounted near viewing window 226 on optical system 200. Thus, the autofocus camera may be used to adjust a focus point and a depth-of-field of a real-world view similar to that viewable by the viewer 222. Further, in adjusting the focus and the depth-of-field of the real-world image viewable along viewing axis 204, the optical path length modulator 224 may be adjusted depending upon the autofocus signal generated by the autofocus mechanism. For instance, if the autofocus camera focuses on a distant target object, a control system coupled to at least the autofocus mechanism and the optical path length modulator 224 may adjust the optical path length modulator 224 such that the displayed virtual image may appear to the viewer 222 at a particular apparent distance based on the autofocus signal.

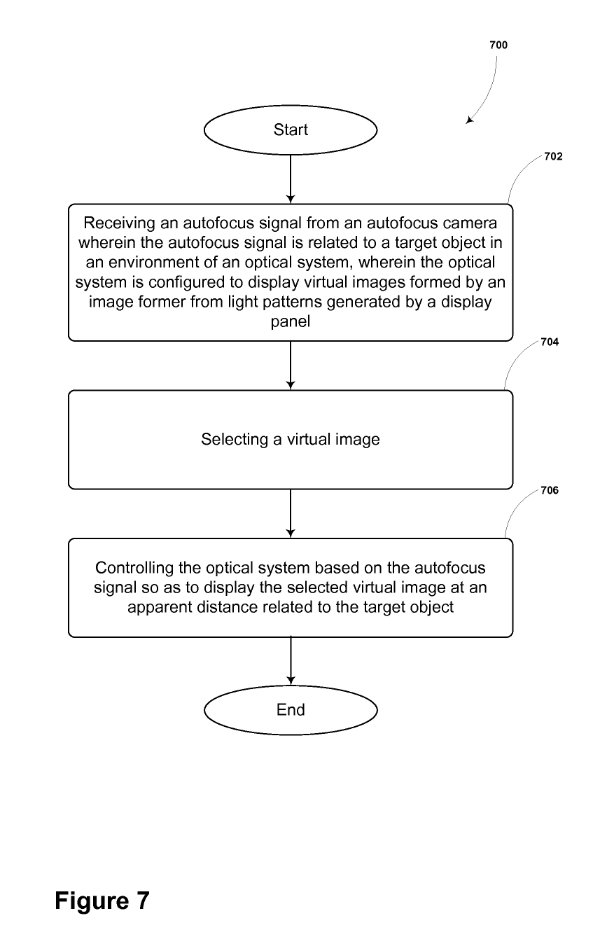

A method 700 is depicted for a possible way to adjust a displayed virtual image based upon an autofocus signal from an autofocus camera. FIG. 7 is a functional block diagram that illustrates the main elements that comprise the method, however, it is understood that the steps may appear in a different order and that various steps may be added or subtracted.

The method 700 may be implemented using HMDs with see-through displays and/or opaque displays in one or both eyes of a HMD wearer. HMDs with see-through displays may be configured to provide a view of the real-world environment and may display virtual images overlaid upon the real-world view. Embodiments with opaque displays may include HMDs that are not configured to provide a view of the real-world environment. Further, the HMD 104 could provide an opaque display for a first eye of the wearer and provide a view of the real-world environment for a second eye of the wearer. Thus, the wearer could view virtual images using his or her first eye and view the real-world environment using his or her second eye.

In method element 702, an autofocus signal is received from an autofocus camera. The autofocus signal may be generated when the autofocus camera is focused on a target object in the environment of the optical system 200. The autofocus mechanism may acquire proper focus on the target object in various ways, including active and/or passive means. Active autofocus mechanisms may include an ultrasonic source or an infrared source and respective detectors. Passive autofocus mechanisms may include phase detection or contrast measurement algorithms and may additionally include an infrared or visible autofocus assist lamp.

Method element 704 includes the selection of a virtual image. The selected virtual image could be, for instance, informational text related to the target object or a graphical highlight that may surround the target object. Alternatively, the selected virtual image may not be related to the target object. For instance, a wearer of the HMD could be performing a task such as reading text and then divert his or her gaze towards an unrelated virtual image or target object in the field of view.

Method element 706 includes the controlling of the optical system based on the autofocus signal so that the virtual image may be displayed at an apparent distance related to the target object. For instance, the virtual image may be displayed at an apparent distance that matches the range to the target object.

The optical path length may then be adjusted (by controlling an optical path length modulator) based on the autofocus signal from the autofocus camera so that the selected virtual image appears at an apparent distance related to the target object. As discussed in a previous embodiment, the autofocus mechanism could directly engage the optical path length modulator 224 or may comprise a lens or set of lenses that could adjust the apparent distance of the virtual image appropriately. Furthermore, the autofocus signal itself may serve as input to the processor 110, which may in turn adjust the optical path length modulator 112. Alternatively, the autofocus signal itself may control the optical path length modulator 112 directly. The autofocus mechanism could provide continuous or discrete autofocus signals independently and/or upon commands by the processor 110 or the HMD user.

The autofocus mechanism may be associated to the camera 432 and be mounted at an arbitrary position on a head-mounted support 409 within the center frame support 418, for example. In the example embodiment, the autofocus mechanism is communicatively coupled to at least the optical path length modulator 224 and thus, changes in the autofocus mechanism focal point and/or depth of field may, based on the autofocus signal, initiate adjustments of the length of optical path 202.

5. Non-Transitory Computer Readable Medium

Some or all of the functions described above and illustrated in FIGS. 6-7 may be performed by a computing device in response to the execution of instructions stored in a non-transitory computer readable medium. The non-transitory computer readable medium could be, for example, a random access memory (RAM), a read-only memory (ROM), a flash memory, a cache memory, one or more magnetically encoded discs, one or more optically encoded discs, or any other form of non-transitory data storage. The non-transitory computer readable medium could also be distributed among multiple data storage elements, which could be remotely located from each other. The computing device that executes the stored instructions could be a wearable computing device, such as wearable computing device 102 illustrated in FIG. 1. Alternatively, the computing device that executes the stored instructions could be another computing device, such as a server in a server network.

A non-transitory computer readable medium may store instructions executable by the processor 110 to perform various functions. For instance, upon receiving an autofocus signal from an autofocus camera, the processor 110 may be instructed to control the length of optical path 202 in order to display a virtual image at an apparent distance related to the wearer of the HMD and/or a target object. Those skilled in the art will understand that other sub-functions or functions may be reasonably included to instruct a processor to display a virtual image at an apparent distance.

### CONCLUSION

The above detailed description describes various features and functions of the disclosed systems, devices, and methods with reference to the accompanying figures. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A head-mounted display (HMD), comprising:
a head-mounted support;
at least one optical system attached to the head-mounted support, wherein the at least one optical system comprises:
a. a display panel configured to generate a light pattern;
b. an image former configured to form a virtual image from the light pattern generated by the display panel;
c. a viewing window configured to allow outside light in from a real-world environment of the optical system;
d. a proximal beam splitter through which the outside light and the virtual image are viewable along a viewing axis;
e. a distal beam splitter optically coupled to the display panel and the proximal beam splitter; and
f. an optical path length modulator configured to adjust an optical path length between the display panel and the image former; and
an autofocus camera configured to image the real-world environment to obtain an autofocus signal; and
a computer, wherein the computer is configured to control the display panel and the optical path length modulator based on the autofocus signal.

2. The head-mounted display of claim 1, wherein the optical path length modulator comprises a voice coil actuator.

3. The head-mounted display of claim 1, wherein the optical path length modulator comprises a stepper motor actuator.

4. The head-mounted display of claim 1, wherein the optical path length modulator comprises a piezoelectric motor.

5. The head-mounted display of claim 1, wherein the optical path length modulator comprises a microelectromechanical system (MEMS) actuator.

6. The head-mounted display of claim 1, wherein the optical path length modulator comprises a shape memory alloy.

7. The head-mounted display of claim 1, wherein the optical path length modulator comprises an electrical-thermal polymer actuator.

8. The head-mounted display of claim 1, wherein the autofocus camera further comprises a range-finder.

9. The head-mounted display of claim 1, wherein the autofocus camera further comprises a passive autofocus mechanism.

10. The head-mounted display of claim 9, wherein the passive autofocus mechanism is configured to use a phase detection algorithm.

11. The head-mounted display of claim 9, wherein the passive autofocus mechanism is configured to use a contrast measurement algorithm.

12. The head-mounted display of claim 9, wherein the passive autofocus mechanism is configured to use an infrared or visible autofocus assist lamp.

13. The head-mounted display of claim 1, wherein the autofocus camera further comprises an active autofocus mechanism.

14. The head-mounted display of claim 13, wherein the active autofocus mechanism is configured to use an ultrasonic source and detector.

15. The head-mounted display of claim 13, wherein the active autofocus mechanism is configured to use an infrared source and detector.

16. A method, comprising:
receiving an autofocus signal from an autofocus camera wherein the autofocus signal is related to a target object in an environment of an optical system, wherein the optical system is configured to display virtual images formed by an image former from light patterns generated by a display panel;
selecting a virtual image; and
controlling the optical system based on the autofocus signal so as to display the selected virtual image at an apparent distance related to the target object.

17. The method of claim 16, wherein the optical system comprises an opaque display.

18. The method of claim 16, wherein the optical system comprises a see-through display.

19. The method of claim 18, wherein the optical system further comprises a viewing window configured to allow outside light in from the environment of the optical system.

20. The method of claim 19, wherein the optical system further comprises a proximal beam splitter through which outside light and virtual images are viewable along a viewing axis.

21. The method of claim 20, wherein the optical system further comprises a distal beam splitter optically coupled to the display panel and the proximal beam splitter.

22. The method of claim 16, wherein receiving an autofocus signal from an autofocus camera further comprises obtaining a range to the target object using a range-finder.

23. The method of claim 16, wherein controlling the optical system based on the autofocus signal further comprises adjusting an optical path length between the display panel and the image former.

24. The method of claim 23, wherein adjusting an optical path length comprises controlling an optical path length modulator.

25. The method of claim 16, wherein the selected virtual image relates to the target object.

26. A non-transitory computer readable medium having stored therein instructions executable by a computing device to cause the computing device to perform functions, comprising:
receiving an autofocus signal from an autofocus camera wherein the autofocus signal is related to a target object in an environment of an optical system, wherein the optical system is configured to display virtual images formed by an image former from light patterns generated by a display panel;
selecting a virtual image; and
controlling the optical system based on the autofocus signal so as to display the selected virtual image at an apparent distance related to the target object.

27. The non-transitory computer readable medium of claim 26, wherein the optical system comprises an opaque display.

28. The non-transitory computer readable medium of claim 26, wherein the optical system comprises a see-through display.

29. The non-transitory computer readable medium of claim 26, wherein controlling the optical system based on the autofocus signal further comprises adjusting an optical path length between the display panel and the image former.

30. The non-transitory computer readable medium of claim 29, wherein adjusting an optical path length comprises controlling an optical path length modulator.
